(19) United States
(12) Patent Application Publication
(10) Pub. No.: US 2016/0098875 A1
(43) Pub. Date: Apr. 7, 2016

(54) DOUBLE LOCK SYSTEM

(71) Applicant: Min Zhong, Boston, MA (US)

(72) Inventor: Min Zhong, Boston, MA (US)

(21) Appl. No.: 14/968,342

(22) Filed: Dec. 14, 2015

Related U.S. Application Data
(63) Continuation of application No. 12/562,218, filed on Sep. 18, 2009, now abandoned.
(60) Provisional application No. 61/172,364, filed on Apr. 24, 2009.

(51) Int. Cl. G07C 9/00; E05B 45/06

(52) U.S. Cl. CPC G07C 9/00119; G07C 9/00174; E05B 45/06

(57) ABSTRACT

A system and method for securing a door with a double lock system. A user may have a key to a personal lock while trusted third-parties may be given keys to a common lock. The keys may wireless control each of the respective lock's functions. In this way, the user can control access by trusted third-parties while maintaining security for a residence.

This application claims the priority date of Provisional Application Ser. No. 61/172,364, entitled DOUBLE LOCK SYSTEM, filed on Apr. 24, 2009, which this application incorporates by reference in its entirety.

### BACKGROUND

The present teachings relate generally to lock systems and, more particularly, to lock systems that permit trusted third-party access.

There are growing numbers of people with medical issues that live at home and desire a sense of security. Elderly people, for example, although not limited thereto, may risk losing their independence for fear of having a medical emergency. Medical alert systems help people at risk of losing their independence feel secure by notifying emergency services when an emergency occurs. Traditional medical alert systems consist of three parts: a personal help button, a communications relay, and the service's dispatch center. When a user needs help, he or she can press the personal help button to establish communication between the communications relay and the dispatch center. The communications relay may permit two-way voice communication between the patient and the dispatch center. A dispatcher at the dispatch center may then contact emergency services and alert them with the user's location.

One limitation of traditional medical alert systems is that trusted third-parties, such as emergency services responding to a call for help, are not able to easily enter a user's locked residence. A dispatcher at the medical alert system dispatch center first needs to make sure that the user's door is unlocked or has to ask about the location of a hidden key so that the responding emergency services personnel can get inside. This takes valuable time, which may affect the user's chance of survival if there is a medical emergency. The length of time until emergency personnel can begin treatment of a user with a medical emergency is directly related to the user's chance of survival.

In many cases the user may not be physically able to unlock the door and may not have a spare key hidden outside. The user may be incapacitated and unable to move or even communicate with the dispatch center. The user may also fear leaving a key hidden outside since a criminal may find it and use it to break in to the residence. When emergency services personnel are unable to get inside they are forced to break down the door, if an ambulance has arrived on the scene first, they may have to wait for police officers or firemen to arrive and break down the door. This wastes valuable time, as does the time it takes to break down the door. Breaking down the door not only causes costly property damage, but also leaves the property unsecured when the emergency services personnel eventually leave.

There are radio frequency (RF) remote-controlled keyless door locks. These enable people to unlock doors easily by pressing a button on a remote control, which may be attached to a key ring. Because such devices utilize radio-frequency technology to send a signal to the lock, users don't even need to aim the remote control at the lock to lock or unlock it. Each remote control has a unique combination encoded into the RF signal that matches with a lockset. This maintains security so that a single remote cannot be used to unlock someone else's door. While useful, remote-controlled keyless door locks do not allow trusted third-parties to unlock a door without the right remote control.

Therefore, it would be beneficial to have a superior lock system for enabling trusted third-parties to unlock a locked door while still maintaining security for the user.

### SUMMARY

The needs set forth herein as well as further and other needs and advantages are addressed by the present embodiments, which illustrate solutions and advantages described below.

The system of the present embodiment includes, but is not limited to: a first lock; a second lock; a user device adapted for unlocking the first lock and locking the second lock; and a third party device adapted for unlocking the second lock.

The method of the present embodiment includes, but is not limited to: locking a first lock; activating a user device to unlock the first lock and lock a second lock; and unlocking the second lock with a third party device.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic illustration of one embodiment of the double lock system;

FIG. 2 is a schematic illustration showing some components of one embodiment of the double lock system;

FIGS. 3A, 39, 3C and 3D are schematic illustrations comparing use of a traditional lock system and one embodiment of the double lock system;

FIG. 4 is a schematic illustration of another embodiment of the double lock system;

FIG. 5 is a block diagram depicting one embodiment of a method of allowing trusted access to a secured access point; and

FIG. 6 is a block diagram depicting another embodiment of a method of allowing trusted access to a secured access point.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

The double lock system disclosed herein allows users to remain secure in their residences while at the same time enabling trusted third-parties to enter. One embodiment of the double lock system comprises both a first lock (hereinafter referred to as “personal lock”) and a second lock (hereinafter referred to as “emergency lock”) used to secure a door, although not limited thereto. Both locks may normally be in the locked position while a user is inside a residence, although not limited thereto. The system may also include a medical alert system which may connect with a dispatch center to summon emergency services, although not limited thereto. When a user needs help, he or she may activate a user device (hereinafter referred to as “personal help button”), which may unlock the personal lock at the same time that it activates the help partner communicator. Some mechanism such as an electromagnetic control, although not limited thereto, may be activated which forces each lock into the locked or unlocked position as needed. The emergency lock may remain locked, or the system may automatically lock the emergency lock if needed, keeping the user secure in the residence until help arrives.

When the responding emergency services personnel arrive, they may use an third party device (hereinafter referred to as “emergency key”) to unlock the emergency lock and enter the residence. The emergency key may be a standard key given out to all emergency services personnel, although not limited thereto. The double lock system may create a uniform procedure for emergency services personnel to gain access to residences of users in need of aid. Because no time is lost in finding a hidden key or breaking down a door, this system helps to shorten the response time and increase the user's chance of survival when confronted with a medical emergency.

Since the door remains locked until emergency personnel arrive, the double lock system gives the user a sense of security. The personal lock can prevent parties who possess an emergency key from entering the residence when they are not needed. Even when the user needs assistance, the emergency lock can prevent anyone without an emergency key from entering the residence. When emergency services personnel leave, they may lock the emergency lock again to assure the residence is secure.

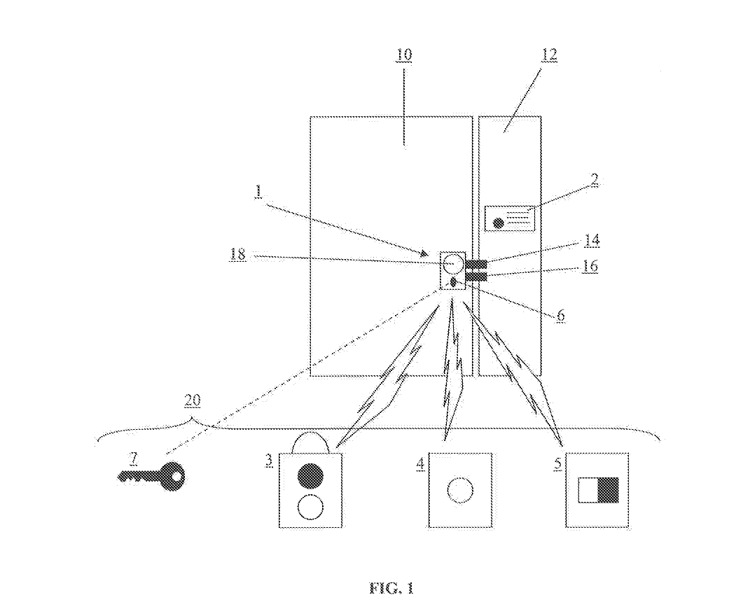

Referring now to FIG. 1, shown is a schematic illustration of one embodiment of the double lock system. The double lock system may comprise: a double lock 1 on a door 10, the double lock 1 having both an emergency lock 16 and a personal lock 14; a help partner communicator 2 (also referred to as “medical alert system communications relay”), which may be located on the door jamb 12, although not limited thereto, which establishes communication with the medical alert service dispatch center; a personal help button 3 which may be carried by a user and may activate the help partner communicator 2 and send out a signal to unlock the personal lock 14; an emergency key 4 that may be used by emergency services or other trusted third-parties to unlock the emergency lock 16; a remote control key 5 (e.g., another embodiment of a user device) that the user may use to lock and unlock both of the locks of the double lock 1 just as they would a traditional set of keys; and a doorknob 18 with a regular key hole 6 and a regular key 7 that may be used to override the double lock system when it fails to work properly.

Both locks of the double lock 1 system may be remotely locked and unlocked by a transmitter that emits coded signals. The user's remote control key 5 may have means for controlling the personal lock 14 and the emergency lock 16 such as a button, although not limited thereto. In fact, any capable device could be used including switches, knobs, etc. Activating each button may remotely lock or unlock the respective lock. When the user leaves the property to run an errand, for example, the user may use the remote control key 5 to lock both the personal lock 14 and the emergency lock 16. When the user returns he or she can again use the remote control key 5 to unlock the door. Similarly, the emergency key 4 may remotely lock or unlock the emergency lock 16. Emergency keys 4 may be given to trusted third parties such as emergency services so that they cart easily unlock a door when they respond to an emergency.

The personal help button 3 may have means to control the personal lock 16 and activate the medical alert system help partner communicator 2 such as buttons, although not limited thereto. In fact, any capable device could be used including switches, knobs, etc. When activated, the personal help button 3 may unlock, the personal lock 16 and activate the medical alert system help partner communicator 2. At the same time, it may also assure that the emergency lock 16 is locked. Pressing a single button on the personal help button 3 may accomplish all of this for the user. Using two locks, the user remains secure in the residence knowing that only he or she can unlock the personal lock 14 and that only trusted third-parties with an emergency key 4 can unlock the emergency lock 16. The user can then wait safely in the residence until emergency services arrives.

Each personal lock 14 may have associated with it a unique code used to remotely unlock it. The emergency lock 16, on the other hand, may use a common code, although not limited thereto. In this way, emergency services can unlock any emergency lock 16 employing the system with a single emergency key 4. However, they will only be able to enter a residence if the user has first unlocked the personal lock 14. This provides the user with a sense of security and control. Any trusted parties, such as responding emergency personnel, family members, and neighbors, although not limited thereto, may be given an emergency key 4 so that they can quickly gain access during an emergency to residences employing the double lock system.

The system may permit use of a regular key 7 (e.g., traditional lock system) to override the locks. The system may be electrically powered by batteries or electricity, although not limited thereto, so a regular key 7 may still be used if there is any interruption in the power supply. The regular key 7 opens the door in case the electric lock does not work. The user may also hide a spare regular key 7 outside the residence in case the electric locks should fail.

A user may carry with them the personal help button 3 at all times while in the residence, although not limited thereto. Activating the personal help button 3 may activate the help partner communicator 2 to alert the dispatch center that there is an emergency at the residence. Activating the personal help button 3 may also send a signal to unlock the personal lock 14 so that any trusted third-parties will be able to enter the residence with an emergency key 4. The help partner communicator 2 may also automatically notify other predetermined trusted third parties, such as neighbors or loved ones. These trusted third parties may also be given an emergency key 4 so that they are able to unlock the emergency lock 16 and enter the residence in an emergency. In this way, if the user finds themselves in trouble, pressing only a single button (or other means of control) may both summon emergency services and permit them to enter the residence without delay.

During normal use by the user, the emergency lock 16 may not be used. In this case, the user may instead use the remote-controlled key 5 to remotely lock, and unlock only the personal lock 14, although not limited to this embodiment. If there is an emergency, the user may activate the personal help button 3 which may unlock the personal lock 14, lock the emergency lock 16, and summon emergency services. In an alternative embodiment, the emergency lock 16 and personal lock 14 may work together during normal use by the user. In this embodiment, the remote-controlled key 5 may be used to simultaneously lock and unlock both locks as needed. This may provide additional security since both locks are engaged when the door is locked. Any combination of lock states may be utilized for operation of the system. Furthermore, more than two locks may be necessary to accomplish the goals stated herein, and the system is not limited to these particular embodiments.

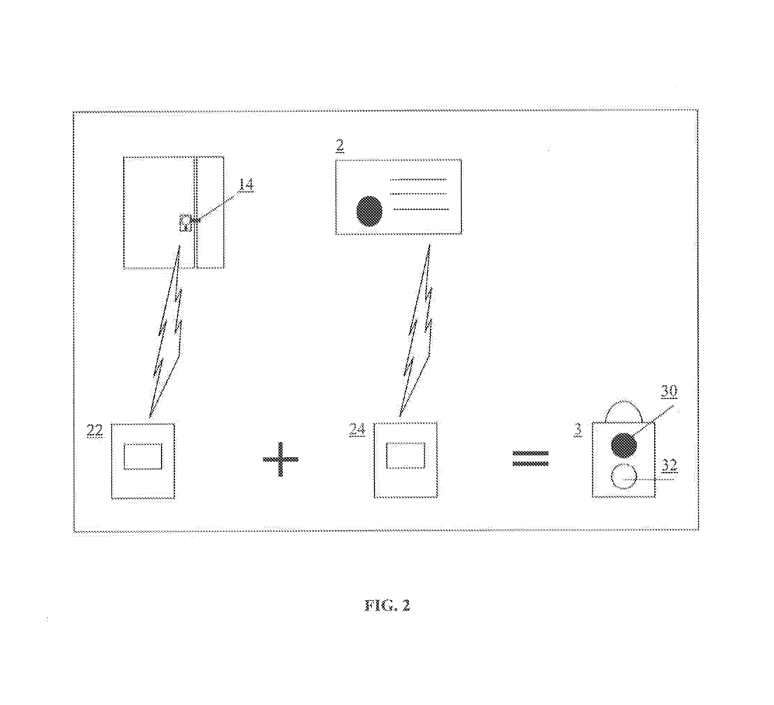

Referring now to FIG. 2, shown is a schematic illustration showing some components of one embodiment of the double lock system. The personal help button 3 is shown, which may be waterproof so that the patient can wear it at all times, even when taking a shower. For example, the personal help button 3 may be worn as a necklace, although not limited thereto. In this way, the user will always feel safe, knowing that emergency services can be summoned. Since the personal help button 3 is wireless, it can be used from any location in the residence.

The personal help button 3 may combine attributes of a wireless lock control 22 and a medical alert control 24. A wireless lock control 22 may be used to lock and unlock a personal lock 14. A medical alert control 24 ma be used to activate a help partner communicator 2. The personal help button 3 may provide both of these functions in a single, easy-to-use, and wearable unit.

The personal help button 3 may have multiple buttons, such as a emergency button 30, which may be red, although not limited thereto, and a unlock button 32, which may be yellow, although not limited thereto. When the user needs help, he or she can push the emergency button 30 to activate the help partner communicator 2, which relays communications between the user and the medical alert dispatch center. When the help partner communicator 2 is activated, it may establish two-way communications between the patient and the dispatch center. The dispatch center may then notify emergency services, a neighbor, a family member, and/or some other trusted third-party.

Activating the emergency button 30 may also send a signal to unlock the personal lock 14 of the double lock system. But the emergency lock 16 (shown in FIG. 1) may remain locked so that no unauthorized people can enter the house. If the emergency lock 16 is unlocked, it may be locked at this time. If the user knows there is someone outside who can help, but that person does not have an emergency key 4 (shown in FIG. 1), the user may activate the unlock button 32, which may unlock both the personal lock 14 and emergency lock 16, providing quick and easy access to the residence.

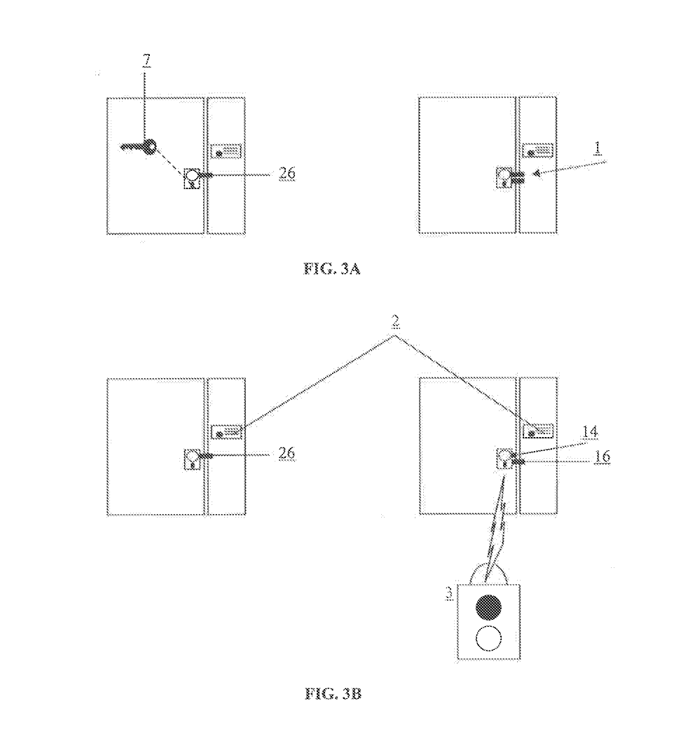

Referring now to FIGS. 3A, 3B, 3C and 3D, shown are schematic illustrations comparing use of a traditional lock system and one embodiment of the double lock system. These demonstrate how the double lock system works, shown on the right, compared with tradition lock systems, shown on the left. Referring to FIG. 3A, normally both the emergency lock 16 and personal lock 14 are locked in the double lock 1. In traditional lock systems, the regular lock 26 would also be locked and would require a regular key 7 to unlock it. Here, both systems prevent people from breaking into the residence and provide security to the user.

Referring now to FIG. 3B, when a user of the double lock system needs help, he or she may activate a personal help button 3, which not only notifies the medical alert dispatch center, but also sends a signal to unlock the personal lock 14. At this time, the personal lock 14 is unlocked, but the emergency lock 16 is still locked. If the emergency lock 16 was unlocked it may be locked at this time. With the traditional lock system, shown on the left, the user may use a help partner communicator 2 to communicate with the dispatch center and summon help, but the regular lock 26 remains locked.

Referring now to FIG. 3C, when emergency services personnel arrive, they can use their emergency key 4 to unlock the emergency lock 16, as shown on the right. Now both the personal lock 14 and emergency lock 16 are unlocked, so emergency services personnel can enter the residence and immediately provide assistance. With the traditional lock system, shown on the left, responding emergency personnel arrive to find that the regular lock 26 (shown in FIG. 3B) is still locked. The dispatch center may then have to contact the user again to ask him or her to open the door, or to find out if a spare key is hidden outside. This wastes valuable time and affects the survival chances of the user. If no key can be found and the user is unable to open the door, emergency services personnel will be forced to break down the door, resulting in a broken lock and door 28.

Referring now to FIG. 3D, after emergency services leaves, both the personal lock 14 and emergency lock 16 of the double lock system may lock automatically, shown on the right. In the alternative, emergency services personnel may use their emergency key 4 to lock the emergency lock 16 when they leave. In this way, the double lock system can continue its function of safeguarding the user's residence. But with the traditional lock system, shown on the left, responding emergency services personnel had to break down the door in order to enter the residence. When the emergency services personnel leave, the broken door will be unlocked and the residence will remain unsecured.

The double lock system has been discussed in terms of emergency services and doors for residences. But the double lock system can be used in any number of different situations to secure any number of access points, with or without communication to a dispatch center. In fact, anywhere where a lock is used is a potential use for this system. And any trusted third-party is a potential recipient of an “emergency key.”

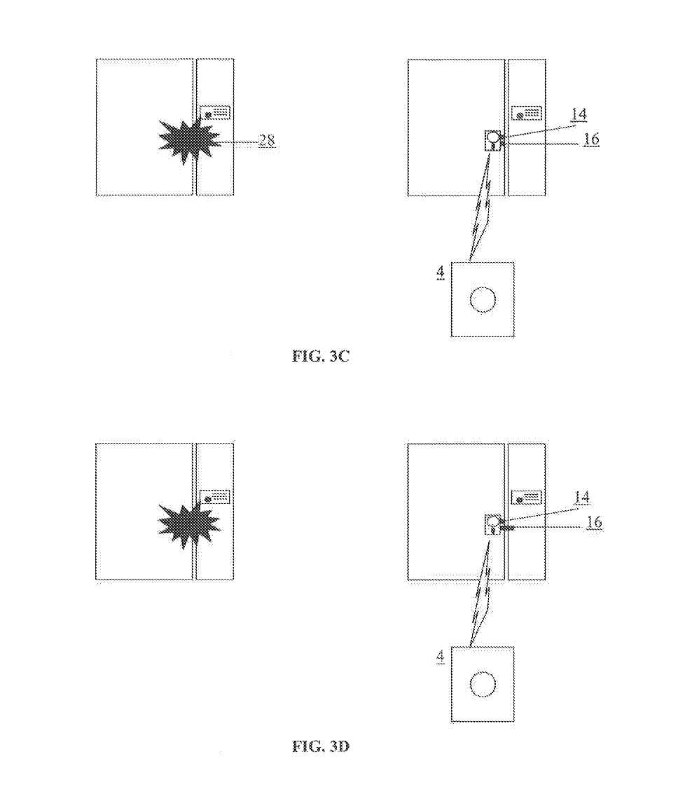

Referring now to FIG. 4, shown is a schematic illustration of another embodiment of the double lock system. A timer 40 (e.g., another embodiment of a user device) or some similar mechanism may be included that changes the state of the locks based on some predetermined event. This may be useful for users who need to allow an employee or other trusted third-party, such as a housekeeper, to use an emergency key 4 to enter the residence when they are not home.

Normally, both the emergency lock 16 and the personal lock 14 are locked. The user may give the housekeeper the emergency key 4 (which can unlock the emergency lock 16) and set a timer 40 for a specific time period during which the personal lock 14 is to be unlocked. For example, if the housekeeper comes to clean the house every Tuesday at three o'clock, the homeowner can set the timer 40 to unlock. the personal lock 14 from 2:45 to 3:15. When the housekeeper arrives, he or she can use the emergency key 4 to unlock the emergency lock 16 and get into the house. However, the housekeeper cannot open the door at any other time because the personal lock 14 would be locked.

The emergency lock 16 may be controlled by a common emergency key 4, or the emergency lock 16 and emergency key 4 may use a unique code. The lock system may permit the ability to easily change the code for either lock, although not limited thereto. For example, a keypad 42 may allow a user to easily change the code for the emergency lock 16 and corresponding emergency key 4. The user may periodically enter a new code with a keypad 42 for additional security and then synchronize the emergency key 4 with the new code. Once set, the new code may be broadcast to the wireless key or each wireless key may have its own keypad for setting the code. This way, if an emergency key 4 is lost, there will be no danger that a criminal could find it and break into the residence.

With the properly-coded emergency key 4, the trusted third-party can easily unlock the emergency lock 16 and enter the residence so long as the personal lock 14 is unlocked. The wireless keys may, use radio frequency technology, light waves such as infrared, or some other method to remotely and securely control the respective locks, although not limited thereto.

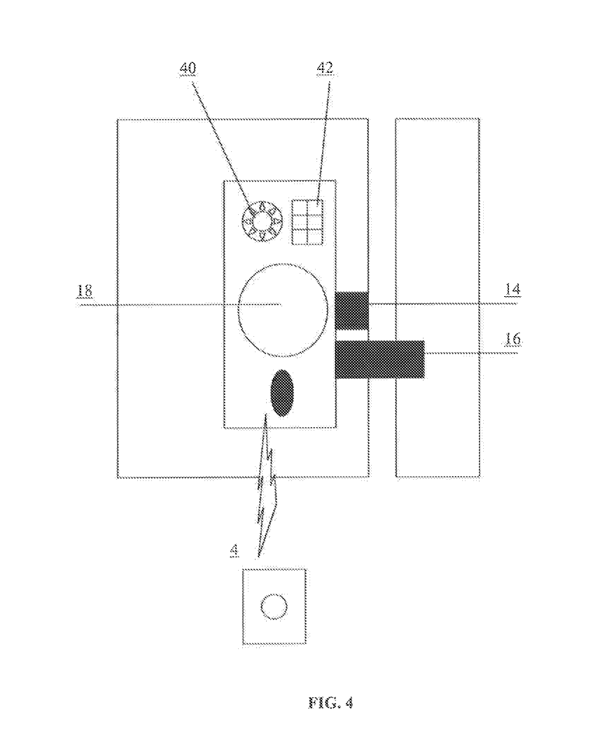

Referring now to FIG. 5, shown is a block diagram depicting one embodiment of a method of allowing trusted access to a secured access point. The method may comprise the following steps, although not limited thereto: having a first lock; having a second lock; having a first device with means for controlling the first and second locks; having a second device with means for controlling the second lock; having a timer with means for controlling the second lock; having an alert system; having a personal help device with means for activating the alert system; and activating the alert system, unlocking the first lock, and locking the second lock.

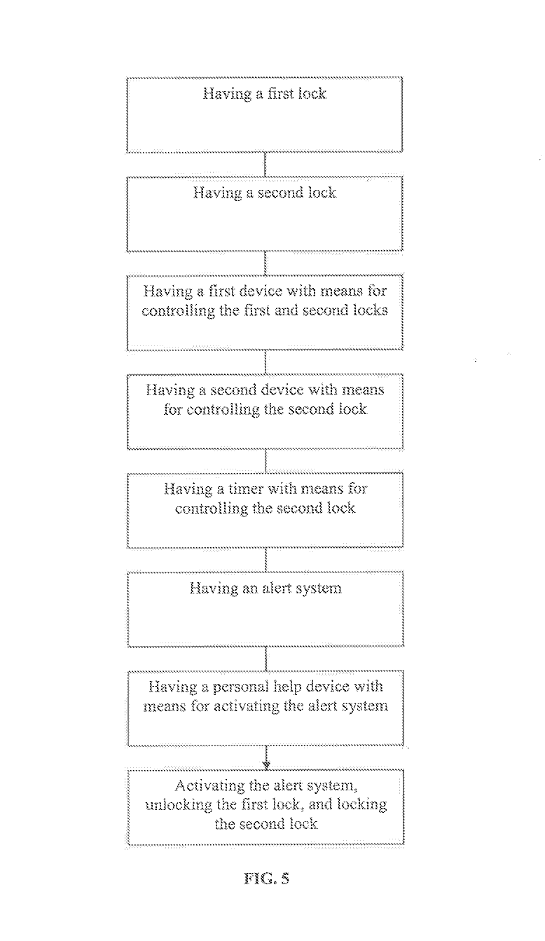

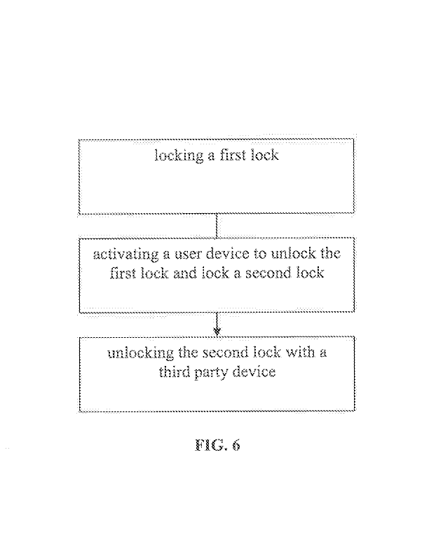

Referring now to FIG. 6, shown is a block diagram depicting another embodiment of a method of allowing trusted access to a secured access point. The method may comprise the following steps, although not limited thereto: locking a first lock; activating a user device to unlock the first lock and lock a second lock; and unlocking the second lock with a third party device. In one embodiment, the method may further comprise the step of alerting emergency services.

In one embodiment of this method, the user device may operate remotely from the first lock. The user device may also be adapted to be worn by a user.

In one embodiment of this method, third party device may operate remotely from the second lock. The third party device may be carried by an emergency responder.

In one embodiment of this method, the user device is a timer.

In one embodiment, the method further comprises the step of operating a keypad, wherein the third party device sends a coded signal to unlock the second lock and the keypad is adapted for setting the coded signal.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

I claim:

1. A double lock system for controlling access to an access point, comprising:
a first lock;
a second lock;
a user device adapted for unlocking the first lock and locking the second lock; and
a third party device adapted for unlocking the second lock.

2. The system of claim 1 wherein the user device operates remotely from the first lock.

3. The system of claim 2 wherein the user device is adapted to be worn by a user.

4. The system of claim 1 wherein the user device is also adapted for locking the first lock.

5. The system of claim 1 wherein the user device is also adapted for unlocking the second lock.

6. The system of claim 1 wherein the third party device operates remotely from the second lock.

7. The system of claim 1 wherein the third party device is also adapted for locking the second lock.

8. The system of claim 1 further comprising an alert system for alerting emergency services;
wherein the user device is also adapted for activating the alert system.

9. The system of claim 1 wherein the user device is a timer.

10. The system of claim 1 further comprising a keypad;
wherein the third party device sends a coded signal to unlock the second lock and the keypad is adapted for setting the coded signal.

11. The system of claim 1 further comprising a key adapted for unlocking the first and second locks.

12. A lock system for controlling access to a residence, comprising:
a personal lock;
an emergency lock;
an alert system for alerting emergency services;
a personal help button capable of being worn by a user and adapted for unlocking the personal lock, locking the emergency lock, and activating the alert system; and
an emergency key adapted for unlocking the emergency lock.

13. A method of operating a lock system for controlling access to an access point, comprising the steps of:
locking a first lock;
activating a user device to unlock the first lock and lock a second lock; and
unlocking the second lock with a third party device.

14. The method of claim 13 further comprising the step of alerting emergency services.

15. The method of claim 13 wherein the user device operates remotely from the first lock.

16. The method of claim 15 wherein the user device is adapted to be worn by a user.

17. The method of claim 13 wherein the third party device, operates remotely from the second lock.

18. The method of claim 17 wherein the third party device is carried by an emergency responder.

19. The method of claim 13 wherein the user device is a timer.

20. The method of claim 13 further comprising the step of operating a keypad;
wherein the third party device sends a coded signal to unlock the second lock and the keypad is adapted for setting the coded signal.
